(19) United States
(12) Patent Application Publication
(10) Pub. No.: US 2010/0053831 A1
(43) Pub. Date: Mar. 4, 2010

(54) WIDEBAND OVERVOLTAGE PROTECTION CIRCUIT

(75) Inventors: Jorge Camacho Sosa-Dias, Madrid (ES); Carlos Fritsch Yusta, Madrid (ES)

Correspondence Address: DARBY & DARBY P.C., P.O. BOX 770, Church Street Station, New York, NY, 10008-0770, US

(73) Assignee: Consejo Superior de Investigaciones Cientificas, Madrid (ES)

(21) Appl. No.: 12/202,897

(22) Filed: Sep. 2, 2008

(51) Int. Cl. H02H 3/20

(52) U.S. Cl. 361/91.5

(57) ABSTRACT

The present patent application describes an approach to the protection of voltage sensitive instruments using a protection circuit that may be easily integrated in a three-terminal device, and which overcomes the drawbacks of previous approaches. The protection circuit of the invention performs very fast against overvoltages (in a few nanoseconds), automatically switching to a low impedance conduction state as soon as the overvoltage situation ends. It also minimizes insertion losses, shows a very low level of thermal noise and allows for obtaining broad bandwidths due to its low serial impedance in the conduction state. Furthermore, it does not require any power source or control signal.

### FIELD OF THE INVENTION

The present invention relates to wideband, low loss overvoltage protection circuit

### BACKGROUND OF THE INVENTION

In many applications, electronic circuits must be protected against overvoltages occurred in input signals. Frequently, these overvoltages occur suddenly and transiently, having high amplitude levels that might destroy some of the devices making up the electronic circuit. A suitable protection circuit must avoid these transient overvoltages reaching the sensitive electronic circuit. Furthermore, the protection circuit must not affect or distort the input signals.

Therefore, it is sometimes unavoidable to have one of these protection circuits, for example, in the case of ultrasonic instruments operating in pulse-echo mode. In order to generate the ultrasonic pulse, high voltages are applied to a transducer (typically, 100 to 500 volt pulses), while an amplifier is connected to the same point for elevating the level of the weak received echo signals. Thus, without a suitable protection, the amplifier could be destroyed.

One solution for this problem is using a solid state switch opening during excitation of the transducer and closing during the reception of the return echoes (N. C. Chaggares, R. K. Tang, and A. N. Sinclair, “Protection circuitry and time resolution in high frequency ultrasonic NDE”, Proc. IEEE Ultrason. Symp., 1999, pp. 819-822). However, this strategy does not detect high voltage transients produced at unexpected times due to cable reflections, cross-talk with other channels or other causes. Another problem is the need of a control signal activating and deactivating the protection circuit. Also, the control signals are frequently contaminated with digital noise that could become coupled into the path of the echo signals, thus reducing the signal-to-noise ratio (SNR).

In order to overcome these drawbacks, other techniques using transmission lines with a length adapted to the frequency of the signal have been proposed. These transmission lines act as an open circuit during excitation and as a short circuit during reception (G. R. Lockwood et al., “The design of Protection Circuitry for High-Frequency Ultrasound Imaging Systems”, in IEEE Trans. Ultrason. Ferroelec. Freq. Control, 38, 1, pp. 48-55, 1991). However, such arrangement is only effective for a specific design frequency.

One alternative is using the wide capacitance variation of a MOSFET transistor with the drain-source voltage: with a low voltage, the capacitance is high, and becomes lower with a high drain-source voltage. Accordingly, during reception (low drain-source voltage), the high capacitance of the MOSFET allows the signals to pass-thorough, while during the high voltage excitation pulse, the low drain-source capacitance blocks the input signal (R. Oppelt et al. “Duplexer including a field-effect transistor for use in an ultrasound imaging system”, U.S. Pat. No. 5,603,324, Feb. 18, 1997). A variation of this method employs variable capacitance diodes (“varicaps”) instead of MOSFET devices (R. Oppelt et al. “Duplexer including a variable capacitance diode for an ultrasound imaging system”, U.S. Pat. No. 5,609,154, Mar. 11, 1997). Main limitations of these alternatives are their dependency on the parameters used during application of the signal and the high variability of the characteristics of the devices.

One common circuit configuration has a resistor connected in series with the input path and a pair of diodes respectively connected back to back in parallel with the output (I. [symbol] içek et al., “Design of a Front-end Integrated Circuit for 3D Acoustic Imaging using 2D CMLPT Arrays”, in IEEE Trans. Ultrason. Ferroelec. Freq. Control, 52, 12, pp. 2235-2241, 2005). Although it is a simple and effective circuit for the purpose of protection, it has some drawbacks: the resistor in series with the input signal produces insertion losses, bandwidth limitations and generates thermal noise. In addition, the circuit is a non negligible load for the transducer driver (pulser), which leads to a high energy consumption.

A further commonly used circuit configuration employs biased diode bridges that automatically switches from a high impedance state to a conduction state depending on the voltage level at the input (T. C. Mooore, V. Soursa, D. Masters, “Preamplifier and protection circuit for an ultrasound catheter”, U.S. Pat. No. 6,251,078, Jun. 26, 2001). Although it is a broadband, low loss, simple circuit, it requires a noise free biasing voltage. In addition, harmonic distortion may appear as a consequence of inserting diodes in the signal path.

Also, the possibility of using depletion MOSFETs for protecting the input of amplifiers is known (Supertex Inc., “±500 volt protection circuit”, AN-11, Aut. 2000). In this case switching is automatic, and bipolar protection is provided. Nevertheless, the impedance of the circuit is approximately 3000 ohm in conduction, giving rise to high insertion losses, a severe limitation of the bandwidth and an important level of thermal noise, particularly when applied to pulse-echo ultrasonic instruments.

### SUMMARY OF THE INVENTION

Dangerous overvoltage situations may occur during normal circuit operation (such as in ultrasonic imaging systems) or be caused by external causes (industrial noise, electric discharges, etc.), which are unexpected situations. Accordingly, it is desirable that the protection circuit be autonomous, in the sense that it should not require any control signal to be effective as soon as the overvoltage situation occurs.

It is also desirable that the protection circuit does not require a power supply, since its failure could cause that of the protection circuit. Also, it would allow for an easier operation.

In addition, during normal operation, the protection circuit must ideally be transparent to the signals, that is, it should not attenuate the signals, limit their bandwidth, introduce noise or distortion in the signals.

Particularly, insertion losses are caused by the signal drop due to the impedance of the protection circuit in relation with the input impedance of the instrument to be protected.

Bandwidth limitations are due to the combined action of the impedance of the protection circuit during normal operation and the parasitic capacities of both the protection circuit, the device input and the PCB (Printed Circuit Board).

Due to the serial impedance of all protection circuits, a certain amount of thermal noise is produced. Thermal noise is given by the following expression:

v_{R}=\sqrt{4KTBR}

where K is the Boltzman constant (1.38·10⁻²³ J/K)

T is the absolute temperature in K

B is the bandwidth in Hz

R is the resistance value in ohms

At room temperature (T=300 K), thermal noise is:

v_{R}≈0.13\sqrt{R} nV/\sqrt{Hz}

Thus, during normal operation it is desirable that a protection circuit have the lowest possible serial impedance to reduce insertion losses and thermal noise and keep a high bandwidth.

On the other hand, the use of non linear elements may produce harmonic distortion in the input signal. Therefore, it is also important that the protection circuit provides a linear operation in the range of the input signal levels.

The present patent application describes an approach to the protection of voltage sensitive instruments using a protection circuit that may be easily integrated in a three-terminal device, and which overcomes the aforementioned drawbacks of previous approaches. The protection circuit of the invention performs very fast against overvoltages (in a few nanoseconds), automatically switching to a low impedance conduction state as soon as the overvoltage situation ends. It also minimizes insertion losses, shows a very low level of thermal noise and allows for obtaining broad bandwidths due to its low serial impedance in the conduction state. Furthermore, it does not require any power source or control signal.

The protection circuit of the present invention may be used in applications related to data transmission, phone lines, signal acquisition systems, measuring instruments, ultrasonic systems, ultrasonic imaging systems, sonar or active transducers. It is specially suitable for protecting ultrasonic imaging instruments operating in pulse-echo mode. In the present document, the term “instrument” will refer to the device the protection circuit of the invention is intended to protect from overvoltages.

The protection circuit of the invention is based on depletion MOSFET transistors. A depletion MOSFET transistor conducts with a gate-source positive voltage, while a large enough negative (N channel) or positive (P channel) voltage between gate and source causes the cutoff of the channel. Also, when the gate-source voltage is zero and the drain-source voltage is high, the depletion MOSFET transistor operates in the saturation region, providing a generally low saturation constant current that may be set in the design and manufacturing process of the transistor.

A first aspect of the invention describes a protection circuit in which a transistor operates between a cutoff state, when there is an overvoltage at the input, and a conduction state when this situation disappears. The protection circuit comprises:
one MOSFET depletion transistor, having its gate connected to the input signal Vx and its drain connected to the output signal Vy;
a first resistor, connected between the source of the transistor and the input signal Vx;
a second resistor, connected between source of the transistor and ground;
a third resistor, connected between drain of the transistor and ground;
a first diode, having its anode connected to the output signal Vy and its cathode connected to ground.
a second diode, having its cathode connected to the output signal Vy and its anode connected to ground.

In one preferred embodiment, the invention comprises an N-channel MOSFET depletion transistor, while a further preferred embodiment comprises a P-channel MOSFET depletion transistor.

In a second aspect of the invention, two MOSFET depletion transistors operate between the saturation region, for limiting the current passing through the device during overvoltage situations, and the conduction region during normal operation. This protection circuit comprises:
a first MOSFET depletion transistor, having its drain connected to the input signal Vx;
a second MOSFET depletion transistor, having its drain connected to the output signal Vy;
a first diode, having its anode connected to the output signal Vy and its cathode connected to ground.
a second diode, having its cathode connected to the output signal Vy and its anode connected to ground.
   wherein the gate of the first transistor is connected to the source of the second transistor, the gate of the second transistor is connected to the source of the first transistor, and the source of the first transistor is connected to the source of the second transistor.

In a preferred embodiment, the source of the first transistor is connected to the source of the second transistor.

In another preferred embodiment, the source of the first transistor is connected to the source of the second transistor through a resistor.

In a further preferred embodiment, both transistors are N-channel MOSFET depletion transistors, and in still a further preferred embodiment, both transistors are P-channel MOSFET depletion transistors.

A third aspect of the invention discloses a protection circuit that comprises a mix of the two aforementioned topologies. In particular, it comprises:
a first MOSFET depletion transistor, having its gate connected to the input signal Vx;
a second MOSFET depletion transistor, having its gate and its source connected to the output signal Vy and its drain connected to the drain of the first transistor;
a first resistor, connected between the source of the first transistor and the input signal Vx;
a second resistor, connected between the source of the first transistor and ground;
a third resistor, connected between the drain of the first transistor and ground;
a first diode, having its anode connected to the output signal Vy and its cathode connected to ground.
a second diode, having its cathode connected to the output signal Vy and its anode connected to ground.

In a preferred embodiment, both transistors are N-channel MOSFET depletion transistors, and in still a further preferred embodiment, both transistors are P-channel MOSFET depletion transistors.

Also, the source of the second transistor may be preferably connected to the output signal Vy through a resistor, in order to further reduce the current in the saturation state.

### BRIEF DESCRIPTION OF THE DRAWINGS

FIG. 1 shows a general diagram of the protection circuit of the invention as a three terminal circuit (E, S and GND), as well as its connection to an external input signal Vx and to the device A to be protected.

FIG. 2 shows a preferred embodiment of the invention having an N channel depletion MOSFET transistor and limiting diodes at the output, in which the protection level against negative overvoltages may be programmed with resistors R1 and R2. That is, the relation between resistors R1 and R2 determines the negative input voltage threshold below which the MOSFET stop conducting.

FIG. 3 shows another preferred embodiment of the invention directed to bipolar protection having two N channel MOSFET depletion transistors and two transient limiting diodes.

FIG. 4 shows one more preferred embodiment of the invention having two N channel MOSFET depletion transistors, a resistance for limiting the current during overvoltage and two transient limiting diodes.

FIG. 5 shows still another preferred embodiment of the invention comprising two N channel MOSFET depletion transistors, in which a first stage allows for programming the protection level against negative overvoltage with resistors R1 and R2, and a second stage that limits the current consumption when a positive overvoltage occurs, and also has transient limiting diodes.

### DESCRIPTION OF PREFERRED EMBODIMENTS

In the figures, equivalent parts appearing in various embodiments have been referenced using the same numerals.

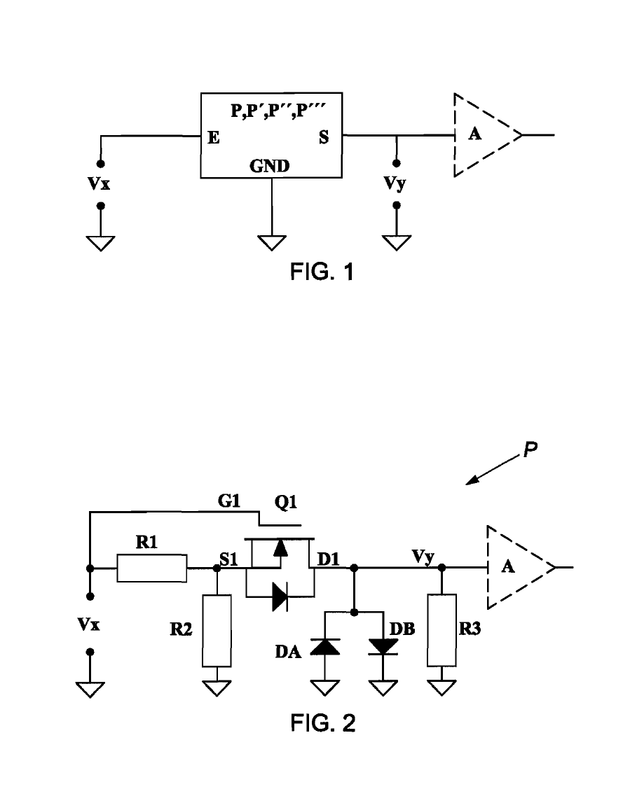

FIG. 1 shows a general scheme of the protection circuit (P, P′, P″, P′″) of the invention, having three terminals:
Input terminal E is connected to the input signal Vx which may be affected by overvoltages.
Output terminal S connects the protection circuit P to the overvoltage protected instrument A.
Common terminal GND is connected to ground.

The protection circuit (P, P′, P″, P′″) of the invention does not require any power source neither control signals. It operates in an automatic way depending on the voltage levels detected at the input terminal E. When the input signal Vx is inside a certain low voltage range with respect to the common terminal GND, the output Vy equals the input voltage Vx multiplied by a constant. When Vx is affected by an overvoltage that exceeds said the upper limit of said range, the protection circuit P switches automatically to a state in which the output voltage Vy is low.

A first example, corresponding to the first aspect of the invention, is displayed in FIG. 2. The protection circuit P comprises a MOSFET depletion transistor Q1, which is an N-channel depletion transistor in the present example. The goal of this protection circuit P is to protect again negative overvoltages.

When a negative overvoltage appears at the input, Vx<<0, transistor Q1 does not conduct, since the voltage between gate G and source S, V_{GS1}, is lower than the conduction threshold voltage, Vₜₕ:

$${V}_{GS 1} = {V}_{x} \frac{R 1}{R 1 + R 2} < {V}_{th}$$

Since transistor Q1 is in cutoff state, the output voltage is Vy=0, and no current passes through third resistor R3. The level Vx=V_{N}<0 for which protection is effective may be programmed adjusting the values of R1 and R2, according to the following expression:

$${V}_{N} = {V}_{th} ( 1 + \frac{R 2}{R 1} )$$

Switching of transistor Q1 can be very fast, however when transients with abrupt edges occur, there are current peaks passing through the parasitic capacities of the transistor Q1. Limiting diodes DA and DB absorb these current peaks, limiting the output voltage Vy to the voltage drop Vd in a directly biased diode (typically between 0.7 and 1.5 V depending on the current peak amplitude).

When an input signal Vₓ>V_{N} is applied, transistor Q1 conducts with a low resistance which depends on the voltage between gate G and source S. Particularly, for input signal Vx levels close to 0, transistor Q1 conducts with a resistance R_{DS} close to the nominal for V_{GS}=0, producing Vy=g·Vx, where g is a factor lower than unity representing the attenuation due to the voltage divider formed by resistors R1 and R2 and to the voltage drop in the transistor with the load resistor R3. For typical output voltage values V_{y}<0.6, diodes DA and DB do not conduct.

When a positive overvoltage occurs, the depletion MOSFET Q1 parasitic diode conducts. However, diode DB will keep output signal Vy limited to a voltage drop Vd, while resistors R1 and R_{DS} together with the impedance of the overvoltage source limit the current.

Therefore, the circuit of FIG. 2 must be rather considered as a monopolar protection circuit for negative overvoltages. A protection circuit for positive overvoltages would be an analogous circuit, only substituting N-channel depletion transistor for a P-channel depletion transistor. Thus, a positive protection circuit cascaded with a negative protection circuit would constitute a bipolar protection circuit, that is, it would protect against both positive and negative overvoltages.

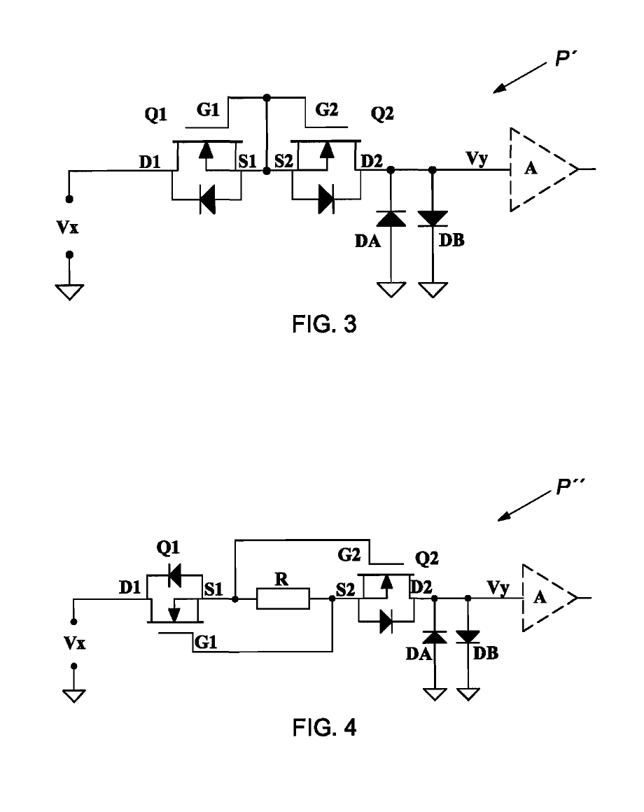

FIGS. 3 (P′) and 4 (P″) disclose two examples corresponding to the second aspect of the invention having two transistors. In a first particular embodiment shown in FIG. 3, both transistors have a short circuit between gate and source, thus always operating with V_{GS}=0. For low values of the voltage between drain and source (V_{DS}<−Vₜₕ, being Vₜₕ the threshold voltage of the transistor), the transistors operate in the linear region, in which they show a low resistance R_{DS} that is determined by the constructive characteristics of the device. For high values of the voltage between drain and source (V_{DS}>−Vₜₕ), the transistors operate in the saturation region, acting as a current source of a value I_{DSS} corresponding to the saturation current of the device.

Thus, for a negative overvoltage at the input, Vx<<0, the parasitic diode associated to transistor Q1 is conducting, and V_{DS2}=Vx−Vd, where Vd=0.7 is the voltage drop in said parasitic diode. In this situation, V_{DS2}<Vₜₕ, and transistor Q2 is operating in the saturation region, having a drain current of I_{DSS}. This current goes through diode DA, which is directly biased, thus limiting the output voltage level to Vy=−0.7 V. Most of the voltage applied at the input drops between drain and source of Q2, that is, V_{DS2}=−Vx+2Vd.

Analogously, for a positive overvoltage at the input, Vx>>0, transistor Q1 operates in the saturation region, and the parasitic diode of Q2 and DB conduct. The current is limited to the saturation current I_{DSS} of transistor Q1, which is diverted to ground through diode DB. Voltage Vy is thus fixed at approximately 0.7 V, the voltage drop of DB.

For low input voltage values, particularly −0.5<Vx<0.5 V, both transistors operate in the linear region, having a low drain-source resistance. In this circuit, the voltage drop in each transistor V_{DS} is related to drain current through the following expression:

$${V}_{DS} = {V}_{th} ( \sqrt{1 - \frac{{I}_{D}}{{I}_{DSS}}} - 1 )$$

Even though its performance is not as linear as a pure resistor, in practice I_{D}<<I_{DSS}, (being I_{DSS} the nominal saturation current of the transistor) and then:

$${V}_{DS} \approx \frac{{V}_{th}}{2 {I}_{DSS}} {I}_{D}$$

that is, the performance is approximately lineal with a resistive value in the order of Vth/2I_{DSS}. This way, the harmonic distortion provided by this circuit is very low, lower than, for example, that produced by other alternatives inserting diodes in the signal path.

Particularly, in contrast with other approaches, transistors Q1 and Q2 always conduct, switching automatically from the linear region to the saturation region for input signals of low and high level, respectively. This protection circuit is thus bipolar, that is, it provides protection both against positive and negative overvoltages. When a positive overvoltage occurs, transistor Q1 is saturated, supporting between its drain and source the voltage exceeding two diode drops. When a negative overvoltage occurs, transistor Q2 is, in turn, saturated, supporting between drain and source the voltage exceeding two diode drops.

The example shown in FIG. 4 shows a second preferred embodiment of the invention having a resistor (R) connected between the sources of the transistors in order to reduce the current through diodes DA and DB when an overvoltage is applied at the input. In this situation, the current flowing through the resistor causes a voltage drop that reduces the gate-source voltage of the saturated transistor. This inverse biasing regulates the current passing through the transistor, reducing it with respect to the nominal current I_{DSS}.

The protection circuit of FIG. 4 is preferred when an overvoltage situation could last for a long time, since the power dissipation in transistors and diodes becomes more important. On the contrary, since resistance R in the signal path causes greater insertion and bandwidth losses, protection circuit of FIG. 3 is preferred for transient overvoltages of short duration.

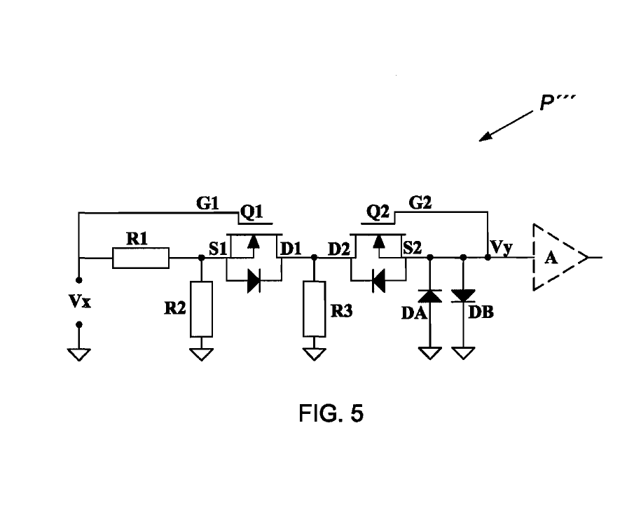

Finally, FIG. 5 shows a preferred embodiment mixing the first two aspects of the invention. Two N-channel MOSFET depletion transistors are used, in such a way that negative overvoltages are blocked by transistor Q1, which does not conduct when its gate-source voltage gets more negative than the threshold voltage. In this situation, the voltage at the drain of transistor Q2 is 0, since no current flows through resistor R3, which can be of high value, and Q2 operates in the linear region, such that Vy=0.

Positive overvoltages pass through the parasitic diode of MOSFET Q1 and are blocked by transistor Q2, which operates in the saturation region. In these conditions, the maximum current in the circuit is the saturation current I_{DSS} for V_{GS}=0 of Q2, which is diverted to ground through diode DB. DB, together with DA, limits the voltage peaks in Vy due to fast transients at the input through the parasitic capacities of the transistors.

When the input signal Vx is close to cero, both transistors operate in the linear region, producing an output Vy=g·Vx, where g is a factor below unity representing the attenuation due to the resistive dividers formed by R1 and R2, and to the series resistance of the transistors in the conduction state with the input resistance of the device to be protected.

### EXAMPLE

Next, experimental results regarding a specific protection circuit (P′) shown in FIG. 3 are shown. Although commercially available components have been used, this protection circuit (P′) would ideally be made in a single device.

The following components have been used:

Q1=Q2=BSS139 (Infineon Technologies AG, Munich, Germany)

V_{DS}max=250 V

R_{DS} max=30 ohm

I_{DSS}=65 mA

Vth=−1.4 V (typ)

DA=DB=BAV99 (Fairchild Semiconductor Corp., Portland, USA)

I_{FRM}=maximum repeating current=700 mA

V_{FM}=maximum forward voltage drop=1.25 V

The external instrument (A) to be protected has been simulated using the following passive components:

RI=input resistor=330 ohm

CI=input parasitic capacity=20 pF

This protection circuit (P′) has been mounted and verified using pulses of −160 V of amplitude and duration in the range of microseconds. The results show that the protection circuit (P′) blocks high voltage pulses, producing output levels below ±1.2 V.

Also, the operation of the protection circuit (P′) has been verified using a sine signal generator with frequencies in the range of 0 to 100 MHz, and measuring insertion losses, bandwidth and harmonic distortion, with a 200 mV peak to peak amplitude. The results were:

| | | |
|---|---|---|
| Total harmonic distortion at 5 MHz: | −95 | dB |
| Bandwidth: | 60 | MHz |
| Insertion losses (R_{L} = 330 ohm): | 5 | dB |
| Overvoltage recovery time: | 200 | ns |
| Maximum output voltage: | ±1.2 | V |

By design, the maximum overvoltage supported by this circuit is ±250 V, which corresponds to the maximum V_{DS} for the selected MOSFET transistors.

1. Protection circuit (P), for protecting an instrument against overvoltages, comprising:
one MOSFET depletion transistor (Q1), having its gate (G1) connected to the input signal Vx and its drain (D1) connected to the output signal Vy;
a first resistor (R1), connected between source (S1) of the transistor (Q1) and input signal Vx;
a second resistor (R2), connected between source (S1) of the transistor (Q1) and ground (GND);
a third resistor (R3), connected between drain (D1) of the transistor (Q1) and ground (GND);
a first diode (DB), having its anode connected to the output signal Vy and its cathode connected to ground (GND);
a second diode (DA), having its cathode connected to the output signal Vy and its anode connected to ground (GND).

2. Protection circuit (P) according to claim 1, wherein the MOSFET depletion transistor (Q1) is an N-channel type transistor.

3. Protection circuit (P) according to claim 1, wherein the MOSFET depletion transistor (Q1) is an P-channel type transistor.

4. Protection circuit (P′, P″), for protecting an instrument against overvoltages, comprising:
a first MOSFET depletion transistor (Q1), having its drain (D1) connected to the input signal Vx;
a second MOSFET depletion transistor (Q2), having its drain (D2) connected to the output signal Vy;
a first diode (DB), having its anode connected to the output signal Vy and its cathode connected to ground (GND);
a second diode (DA), having its cathode connected to the output signal Vy and its anode connected to ground (GND).
wherein the gate (G1) of the first transistor (Q1) is connected to the source (S2) of the second transistor (Q2), the gate (G2) of the second transistor (Q2) is connected to the source (S1) of the first transistor (Q1) and the source (S1) of the first transistor (Q1) is connected to the source (S2) of the second transistor (Q2).

5. Protection circuit (P″) according to claim 4, wherein the source (S1) of the first transistor (Q1) is connected to the source (S2) of the second transistor (Q2) through a resistor (R).

6. Protection circuit (P′, P″) according to claim 4, wherein both MOSFET depletion transistors (Q1, Q2) are N-channel type transistors.

7. Protection circuit (P′, P″) according to claim 4, wherein both MOSFET depletion transistors (Q1, Q2) are P-channel type transistors.

8. Protection circuit (P′″) for protecting a device against overvoltages, comprising:
a first MOSFET depletion transistor (Q1), having its gate (G1) connected to the input signal Vx;
a second MOSFET depletion transistor (Q2), having its gate (G2) and its source (S2) connected to the output signal Vy and its drain (D2) connected to the drain (D1) of the first transistor (Q1);
a first resistor (R1), connected between the source (S1) of the first transistor (Q1) and the input signal Vx;
a second resistor (R2), connected between the source (S1) of the first transistor (Q1) and ground (GND);
a third resistor (R3), connected between the drain (D1) of the first transistor (Q1) and ground (GND);
a first diode (DB), having its anode connected to the output signal Vy and its cathode connected to ground (GND);
a second diode (DA), having its cathode connected to the output signal Vy and its anode connected to ground (GND).

9. Protection circuit (P′″) according to claim 8, wherein the source (S2) of the second transistor (Q2) is connected to the output signal Vy through a resistor.

10. Protection circuit (P′″) according to claim 8, wherein both MOSFET depletion transistors (Q1, Q2) are N-channel type transistors.

11. Protection circuit (P′″) according to claim 8, wherein both MOSFET depletion transistors (Q1, Q2) are P-channel type transistors.

12. A voltage protection circuit, comprising:
a current regulator configured to receive an input voltage, the regulator comprising:
a switch;
a first diode having a first side connected to an output of the switch and a second side connected to electrical ground, the first diode having a predetermined conductive direction; and
a second diode connected in parallel with the first diode, the second diode having a conductive direction opposite to the conductive direction of the first diode,
wherein a protected output voltage is formed at the connection between the switch and the first diode.

13. The circuit of claim 12, wherein the switch comprises a MOSFET.

14. The circuit of claim 13, further comprising a resistive divider across the input voltage, wherein the input voltage is provided to the gate of the MOSFET and the divided voltage is provided to the source of the MOSFET.

15. The circuit of claim 13, further comprising a second MOSFET, wherein: the drain of the first MOSFET is connected to the input voltage; the source of the first MOSFET, the source of the second MOSFET, the gate of the first MOSFET and the gate of the second MOSFET are all electrically connected; and the drain of the second MOSFET is connected to the first diode.

16. The circuit of claim 13, further comprising:
a second MOSFET; and
a predetermined resistor connected between the source of the first MOSFET and the source of the second MOSFET,
wherein: the drain of the first MOSFET is connected to the input voltage;
the source of the first MOSFET is connected to the gate of the second MOSFET;
the source of the second MOSFET is connected to the gate of the first MOSFET; and the drain of the second MOSFET is connected to the first diode.

17. The circuit of claim 13, comprising:
a second MOSFET, wherein the drain of the first MOSFET is connected to the drain of the second MOSFET, and the source of the second MOSFET is connected to the gate of the second MOSFET and connected to the first diode;
a predetermined resistor connected between the drain of the first MOSFET and electrical ground; and
a resistive divider across the input voltage, wherein the input voltage is provided to the gate of the first MOSFET and the divided voltage is provided to the source of the MOSFET,
